(19) United States
(12) Patent Application Publication
(10) Pub. No.: US 2019/0134559 A1
(43) Pub. Date: May 9, 2019

(54) PROCESS AND APPARATUS FOR PRODUCING A PRODUCT GAS STREAM

(71) Applicant: Leibniz-Institut für Plasmaforschung und Technologie E.V., Greifswald (DE)

(72) Inventors: Ansgar SCHMIDT-BLEKER, Griefswald (DE); Klaus-Dieter WELTMANN, Binz (DE)

(73) Assignee: Leibniz-Institut für Plasmaforschung und Technologie E.V., Greifswald (DE)

(21) Appl. No.: 16/095,367

(22) PCT Filed: Apr. 21, 2017
(86) PCT No.: PCT/EP2017/059537

§ 371 Date: Oct. 21, 2018

(30) Foreign Application Priority Data
Apr. 21, 2016 (EP) 16166491.7

(51) Int. Cl. B01D 53/60; C01B 13/02; C01B 13/11; C01B 15/01; C01B 21/20; C01B 21/36; C01B 21/38

(52) U.S. Cl. CPC B01D 53/60; C01B 13/0203; C01B 13/11; C02F 1/72; C01B 21/203; C01B 21/36; C01B 21/38; C01B 15/01

(57) ABSTRACT

The invention relates to a method for generating a product gas stream (G), comprising the steps: provision of a process gas stream (P), generation of a reactive gas stream (R) from the process gas stream (P) at reduced pressure, provision of a compressed gas stream (D) and mixing the reactive gas stream (R) with the compressed gas stream (D) with formation of a product gas stream (G).

The invention further relates to an apparatus (1) for generating a product gas stream (G), comprising a discharge chamber (2), a compressed gas line (12), a reactive gas line (11), which is realized separately from the compressed gas line (12), a product gas line (13) and a mixing chamber (3), which can be brought into flow connection with the compressed gas line (12) and the reactive gas line (11) in such a way, in that, in the mixing chamber (3), the compressed gas stream (D) can be mixed with the reactive gas stream (R) to form a product gas stream (G), wherein the mixing chamber (3) can be brought into flow connection with the product gas line (13) in such a way that the product gas stream (13) can be discharged from the apparatus (1) by means of the product gas line (13).

The invention relates to a method and an apparatus for generating a reactive product gas stream, in particular for use in an air or exhaust gas purification process, a hygienic or therapeutic method.

According to prior art, various so-called DENOX processes for denitrification or DESONOX processes for denitrification and desulphurisation of exhaust gases are known. In the oxidative DENOX processes, pollutants such as nitrogen monoxide (NO) or nitrogen dioxide (NO₂) are converted into nitrous acid (HNO₂) or nitric acid (HNO₃). In the DESONOX processes, SO₂ or SO₃ can be converted to sulphurous acid or sulphuric acid analogously (Skalska et al., Trends in NOₓ abatement: A review. Science of the total environment 408 (19), 2010: 3976-3989). Radicals such as OH or atomic oxygen serve as oxidizing agents. Such radicals can be advantageously generated by non-thermal plasmas known from prior art (Chang et al., Removal of SO₂ and the simultaneous removal of SO₂ and NO from simulated flue gas streams using dielectric barrier discharge plasmas; Plasma Chemistry and Plasma Processing 12 (4), 1992: 565-580; Khacef & Cormier, Pulsed sub-microsecond dielectric barrier discharge treatment of simulated glass manufacturing industry flue gas: removal of SO₂ and NOₓ; Journal of Physics D: Applied Physics 39(6), 2006: 1078).

In many processes according to prior art, harmful intermediate or by-products are produced, such as carbon monoxide or ozone, because the entire exhaust gas passes through the plasma reactor.

In other processes, the plasma is generated in a separate reaction chamber and then supplied to the exhaust gas. For example, a process is known in which a carrier gas stream is passed through a plasma source and entrains reactive gas particles (WO 2008138504A1).

Various plasma source concepts exist which are intended for hygienic or therapeutic use. The prior art provides in particular a device that uses a venturi or Laval nozzle to create a low pressure area in a gas stream, allowing lower ignition voltages and more efficient plasma generation (WO 2008138504A1). The generated plasma and/or reactive gas is then provided via an opening for further, in particular therapeutic or hygienic, use.

Furthermore, document DE10 2013 016 660 A1 discloses a process and a device for the plasma catalytic conversion of substances, in which, in particular, a product stream is formed. However, this product stream itself does not contain any reactive species and is therefore not suitable, in particular, for therapeutic or hygienic use and for the said denitrification and desulphurisation processes.

Consequently, the problem is to provide an effective, cost-effective and safe method and an apparatus for generating a reactive product gas stream, in particular for use in an air or exhaust gas purification process or a hygienic or therapeutic process.

This problem is provided, on the procedural side, by the subject matter of the independent claim 1 and on the apparatus side by the subject matter of the independent claim 13. Furthermore, a product gas stream is provided with the subject matter of the independent claim 10 and different uses of the method according to the invention are provided with the subject matter of the independent claim 12.

Embodiments of the invention are indicated in the corresponding dependent claims and are described below.

According to a first aspect of the invention, a method for generating a product gas stream is provided, the method comprising the following steps: provision of a process gas stream of a process gas; provision of a reactive gas stream by generating a reactive gas from the process gas by means of a discharge chamber at reduced pressure compared to atmospheric pressure, in particular 10 mbar to 1000 mbar absolute pressure; provision of a compressed gas stream of a compressed gas and mixing the reactive gas stream with the compressed gas stream with formation of a product gas stream.

Thereby the process gas is generated by a plasma source with a discharge chamber realized according to the prior art. For example, a dielectric barrier discharge (DBD), a micro hollow cathode discharge (MHCD), a corona discharge, a microwave plasma, a capacitively coupled plasma (CCP) or an inductively coupled plasma (ICP) can be used.

In the context of the present invention, the term compressed gas refers to a gas, gas mixture or a mixture of one or more gases and one or more liquids, which has a pressure of 2 to 8 bar. The compressed gas can be, for example, air, water vapour or CO₂ or mixtures of the said gases. The compressed gas stream serves in particular for generating a product gas stream by mixing with the reactive gas stream and/or for generating the reduced pressure, in particular by flowing of the compressed gas stream through a jet pump.

In the context of the present invention, the term reactive gas refers to a gas, gas mixture or a mixture of one or more gases and one or more liquids, which has components with a minimum volume fraction of 1 ppm (parts per million), which after generation participate in further reactions with themselves or other components of the reactive gas and can therefore not be stored for longer than one hour, wherein the reactive components can in particular be radicals. The reactive gas may, for example, comprise OH radicals, atomic oxygen, hydrogen peroxide (H₂O₂), ozone (O₃), hydroperoxyl radicals (HO₂), nitrogen monoxide (NO), nitrogen dioxide (NO₂), nitrate (NO₃⁻), nitrite (NO₂⁻) peroxynitrite (ONOOH), nitrous acid (HNO₂) or nitric acid (HNO₃) or mixtures of the above components. Furthermore, the reactive gas may naturally comprise components of the process gas which, for example, have not been converted into reactive components by the plasma discharge in the discharge chamber.

In the context of the present invention, the term process gas refers to a gas, gas mixture or a mixture of one or more gases and one or more liquids which can be converted into a reactive gas by means of a discharge chamber. Components of the process gas are converted into the reactive components of the reactive gas by means of a plasma discharge. It goes without saying that the process gas may additionally also comprise components that are not converted into the reactive components of the reactive gas. The process gas can comprise e.g. air, water vapour, hydrogen peroxide (H₂O₂), nitrogen (N₂), oxygen (O₂), a noble gas, carbon dioxide (CO₂), nitrous acid (HNO₂), nitric acid (HNO₃) and/or an alcohol.

In the context of the present invention, the term product gas means a gas comprising a mixture of the reactive gas and the compressed gas. In addition, the product gas may comprise other components, e.g. an aerosol of a liquid and an abrasive, micro- or nanoparticles. As explained below, a first product gas stream can be formed by mixing the compressed gas stream and the reactive gas stream, and the first product gas stream can be mixed with an additive gas stream to form a second product gas stream.

Advantageously, the reduced pressure allows the plasma to be ignited with a lower energy input compared to atmospheric pressure plasmas. In addition, the reduced pressure counteracts the recombination of formed radicals in an advantageous manner, which allows a higher yield of reactive gas.

By mixing the reactive gas stream with the compressed gas stream, a surface treated with the product gas stream does not come into direct contact with the plasma, resulting in advantages with regard to protective measures in medical applications, since, for example, no leakage current occurs.

According to one embodiment, at least one component of the process gas is provided by evaporating a liquid selected from water, hydrogen peroxide (H₂O₂), nitrous acid (HNO₂), nitric acid (HNO₃) or an alcohol or a mixture of these liquids.

According to further embodiment, at least one component of the process gas is provided by evaporating a liquid selected from water, hydrogen peroxide (H₂O₂), nitrous acid (HNO₂) or nitric acid (HNO₃) or a mixture of these liquids.

In particular, at least one component of the process gas is provided by evaporation of water.

According to a further embodiment, the process gas comprises air, water vapour, hydrogen peroxide (H₂O₂), nitrogen (N₂), oxygen (O₂), a noble gas and/or carbon dioxide (CO₂) or a mixture of the preceding and/or other gases.

According to a further embodiment, the process gas comprises air, water vapour, hydrogen peroxide (H₂O₂), nitrogen (N₂), oxygen (O₂), a noble gas and/or carbon dioxide (CO₂) or a mixture of the preceding and/or other gases.

The said substances can advantageously be converted into hydrogen peroxide (H₂O₂) and/or nitrite (NO₂⁻) by means of a plasma discharge. These react with each other particularly under acidic conditions to form peroxynitrite (ONOOH), which has an antimicrobial effect.

According to one embodiment, the reduced pressure is used to mix the reactive gas stream with the compressed gas stream.

According to a further embodiment, the reduced pressure is generated by means of the compressed gas stream.

According to a further embodiment, the reduced pressure is generated by means of a jet pump, in particular comprising a nozzle, for example a venturi nozzle or a Laval nozzle.

If a jet pump with nozzle is used, in particular, a negative pressure is generated by a maximum dynamic pressure prevailing at a narrow point of the nozzle in relation to a space in flow connection with the jet pump.

According to a further embodiment, the compressed gas is obtained from liquefied gas, in particular liquefied carbon dioxide (CO₂).

Advantageously, when using air or an air/water vapour mixture, an additional gas supply, e.g. with noble gases, can be dispensed with, as these gases can, for example, be provided by compressors and evaporators.

According to a further embodiment, the reactive gas is produced at a temperature of 15° C. to 200° C., in particular 20° C. to 30° C.

The use of a non-thermal plasma advantageously reduces the energy costs of the method. Furthermore, the use of a non-thermal plasma permits the generation of a tissue-compatible product gas stream with a temperature of 20° C. to 40° C. and thus a therapeutic application.

According to a further embodiment, the liquid is evaporated at reduced pressure, in particular 20 mbar to 800 mbar absolute pressure.

This reduces the required evaporation temperature of the liquid in an advantageous manner, which saves energy for heating the liquid or eliminates the need for an additional heating element.

According to a further embodiment, the liquid is evaporated by means of the heat released during operation of the discharge chamber.

This advantageously saves energy for heating the liquid.

According to a further embodiment, at least a part of the process gas stream is branched off from the process gas stream to provide the compressed gas stream.

According to a further embodiment, the process gas stream is divided into a first partial stream to provide the compressed gas stream and a second partial stream to provide the reactive gas stream. In particular, the second partial stream is introduced into the discharge chamber to form the reactive gas stream.

According to a further embodiment, the pressure of the second partial flow is reduced, in particular by means of a throttle valve, in particular before being introduced into the discharge chamber.

According to a further embodiment, the process gas has sufficient pressure to provide the compressed gas stream when the compressed gas stream is branched off from the process gas stream.

With this embodiment, the provision of a separate compressed gas stream is advantageously unnecessary.

According to a further embodiment, the heat generated during the generation of the reactive gas from the process gas is used to evaporate the liquid.

According to a further embodiment, a pressure is generated by the evaporation of the liquid.

According to a further embodiment, a stream of a evaporated liquid is mixed with a feed gas stream to generate the process gas stream.

According to a further embodiment, at least a part of the evaporated liquid is introduced into the compressed gas stream.

According to a further embodiment, the reactive gas and/or the reactive gas stream comprises radicals, in particular OH radicals, nitrogen monoxide and/or atomic oxygen.

According to a further embodiment, the product gas and/or the product gas stream comprises radicals, in particular OH radicals, nitrogen monoxide and/or atomic oxygen.

According to a further embodiment, a first product gas stream is formed by mixing the compressed gas stream and the reactive gas stream and the first product gas stream is mixed with an additive gas stream of an additive gas with formation of a second product gas stream.

According to a further embodiment, the additional gas stream is mixed with the first product gas stream by means of a jet pump.

According to a further embodiment, a chemical reaction takes place between a component of the first product gas stream, in particular OH, and a component of the additive gas stream, in particular NO₂, in particular with formation of peroxynitrous acid (HOONO).

According to a further embodiment, the reactive gas stream is mixed with a liquid with formation of an aerosol, wherein the product gas stream comprises the aerosol.

By generating the aerosol and the related maximization of the liquid droplet surface, the transport of reactive species into the liquid droplets is advantageously facilitated.

According to a further embodiment, the aerosol is directed onto a baffle plate, in particular after discharge from the nozzle.

According to a further embodiment, larger droplets, in particular droplets with a minimum diameter of 1 μm to 100 μm, are separated from the aerosol by means of a collecting basin.

This allows generating an aerosol with particularly small drops of liquid. The generation of droplets with a small diameter is advantageous, as the reactive species can be better dissolved in these droplets due to the larger surface-to-volume ratio.

According to a further embodiment, the liquid formed from the separated liquid droplets is at least partially used for further generation of the aerosol.

According to a further embodiment, the reactive gas stream, the compressed gas stream and/or the product gas stream are mixed with the liquid, in particular by means of the jet pump.

According to a further embodiment, the reactive gas stream is mixed with the liquid

According to a further embodiment, the compressed gas stream is mixed with the liquid.

According to a further embodiment, the product gas stream is mixed with the liquid.

According to a further embodiment, the reactive gas stream and the compressed gas stream is mixed with the liquid.

According to a further embodiment, the formed product gas stream is introduced into the liquid and the liquid mixed with the product gas stream is mixed again with the reactive gas stream.

In this, high concentrations of reactive species, in particular O₃, H₂O₂, HNO₂, HNO₃ and/or HOONO, depending on the process gas used, can be advantageously achieved.

According to a further embodiment, the product gas stream or the reactive gas stream and the compressed gas stream is mixed, in particular by means of the jet pump, with a particle stream, in particular comprising an abrasive, micro- or nanoparticles.

According to a further embodiment, the particle stream comprises an abrasive and microparticles, an abrasive and nanoparticles or microparticles and nanoparticles.

According to a further embodiment, the reactive gas stream is mixed with the particle stream.

According to a further embodiment, the compressed gas stream is mixed with the particle stream.

According to a further embodiment, the product gas stream is mixed with the particle stream.

According to a further embodiment, the reactive gas stream and the compressed gas stream is mixed with the particle stream, in particular by means of the jet pump.

According to a further embodiment, the particle stream is mixed with the reactive gas stream and the compressed gas stream by means of the nozzle, in particular the venturi nozzle or Laval nozzle.

By using an additional particle stream, mechanical removal, in particular of biofilms during plasma treatment, can be advantageously achieved.

According to a further embodiment, the reactive gas is condensed, in particular by introduction into a second liquid or a cooling device.

According to a further embodiment, the compressed gas is dried before the reactive gas is introduced into the compressed gas stream.

According to a further embodiment, the process gas is dried before being introduced into the discharge chamber.

According to a further embodiment, the process gas is formed by introducing a feed gas stream into a liquid, in particular by means of a gas washing bottle.

According to a further embodiment, the gas is introduced into the liquid at reduced pressure, in particular 20 mbar to 800 mbar absolute pressure.

By this, a better enrichment of the process gas with the liquid is advantageously achieved. In particular, the low pressure can ensure that the boiling temperature of the respective liquid is at or below the respective ambient temperature.

According to a further embodiment, at least one component of the product gas is dissolved by introducing it into a liquid.

According to a further embodiment, by increasing or decreasing the pressure prevailing in the discharge chamber, a switch is made between an O₃-dominated state and a NOₓ-dominated state of the discharge chamber, and wherein

according to a first alternative at a gas temperature of the gas contained in the discharge chamber, in particular the reactive and/or process gas, between 20° C. and 150° C., the O₃-dominated state is present in the discharge chamber at a pressure of 600 mbar to 1000 mbar and the NOₓ-dominated state is present in the discharge chamber at a pressure of 20 mbar to 400 mbar, or

according to a second alternative at a gas temperature of the gas contained in the discharge chamber, in particular the reactive and/or process gas, between 150° C. and 200° C., the O₃ dominated state is present at a pressure of 800 mbar to 1000 mbar and the NOₓ dominated state is present at a pressure of 20 mbar to 600 mbar.

Between the indicated pressure ranges, i.e. in the case of the first alternative between 400 mbar and 600 mbar and in the case of the second alternative between 600 mbar and 800 mbar, there is in particular no O₃ dominated or NOₓ dominated state, but there is a mixture of O₃ and NOₓ, wherein the concentrations of O₃ and NOₓ in particular are essentially the same.

Switching can take place both from the O₃ dominated state to the NOₓ dominated state and from the NOₓ dominated state to the O₃ dominated state.

In the O₃ dominated state, the reactive gas produced and, thus, the product gas stream contain more O₃ than NOₓ. In contrast, the reactive gas produced and thus the product gas stream in the NOₓ dominated state contains more NOₓ than O₃. NOₓ is the generalized sum formula of various nitrogen oxides.

This means that during said switching between the O₃ dominated and NOₓ dominated state, the chemical composition of the produced reactive gas and thus of the product gas stream is switched from ozone (O₃) dominated to nitrogen oxide (NOₓ) dominated by reducing the pressure in the discharge chamber, or switched from NOₓ dominated to O₃ dominated by increasing the pressure.

This increases the variability of the generated product gas stream so that, for example, the antimicrobial effect against different microorganisms can be improved.

According to a second aspect of the invention, a product gas stream, generated by a method according to the first aspect of the invention, is provided. The product gas stream is used in an air purification process, in particular an exhaust air purification process, a denitrification and/or desulphurisation process (e.g. a so-called DENOX or DESONOX process), a water treatment or water purification process, in particular an advanced oxidation process, a surface functionalisation process, in particular of polymers, a sterilisation, disinfection or decontamination process, in particular of surfaces, medical devices, body surfaces, textiles or wound dressings, a process for producing nitrates or nitrites, in particular polynitrite, a process for producing hydrogen or synthesis gas or a therapeutic process.

The term(s) denitrification and/or desulphurisation process (e.g. so-called DENOX and DESONOX processes) in the context of the present application comprise in particular an oxidation of nitric oxide (NO) by means of OH radicals to nitrous acid (HNO₂), an oxidation of nitrogen dioxide (NO₂) by means of OH radicals to nitric acid (HNO₃), an oxidation of nitrogen monoxide (NO) to nitrogen dioxide (NO₂) by means of atomic oxygen (O) and/or an oxidation of nitrogen monoxide (NO) to nitrogen dioxide (NO₂) by means of HO₂, wherein HO₂ can be formed from atomic hydrogen by reaction with oxygen (O₂).

Denitrification and desulfurization processes (e.g. so-called DESONOX processes) in the context of this application additionally comprise an oxidation of sulphur dioxide (SO₂) to HOSO₂ by means of OH radicals, in particular with the formation of sulphur trioxide (SO₃) from oxygen (O₂) and HOSO₂ and with the formation of sulfuric acid (H₂SO₄) from sulphur trioxide (SO₃) and water (H₂O) and/or an oxidation of sulphur dioxide (SO₂) to sulphur trioxide (SO₃) by means of atomic oxygen (O).

Such processes are particularly suitable for the denitrification and/or desulphurisation of exhaust gases.

Furthermore, using OH radicals, carbon monoxide (CO) can be oxidized to carbon dioxide (CO₂).

Advantageously, the produced acids HNO₂, HNO₃ and H₂SO₄ can be washed out of the product gas by known technical processes and further processed, in particular in the chemical industry, for example for the production of fertilizers.

According to a third aspect, a product gas stream is provided comprising at least 10 mg/L hydrogen peroxide (H₂O₂) and at least 10 mg/L nitrite (NO₂⁻), in particular at least 50 mg/L hydrogen peroxide (H₂O₂) and at least 50 mg/L nitrite (NO₂⁻), preferably at least 100 mg/L hydrogen peroxide (H₂O₂) and at least 100 mg/L nitrite (NO₂⁻), more preferably at least 350 mg/L hydrogen peroxide (H₂O₂) and at least 350 mg/L nitrite (NO₂⁻). The substances mentioned have a half-life in the range of minutes and are therefore not storable in this combination.

According to one embodiment, the product gas stream is generated by a method according to the first aspect of the invention.

By means of the method according to the invention, it is particularly possible to provide extremely short-lived reactive components (such as hydrogen peroxide and nitrite), e.g. on a surface of a body, so that these react on this surface to antimicrobially active substances, which unfold their antimicrobial effect on the surface.

According to a further embodiment, the product gas stream has a pH value of 6.0 or less, in particular 4.0 or less, preferably 3.5 or less, further preferred 3.0 or less, even further preferred 2.5 or less.

A fourth aspect of the invention relates to the use of the method according to the first aspect or the product gas stream according to the second or third aspect in
a. an air purification process, in particular an exhaust air purification process,
b. a denitrification and/or desulphurisation process,
c. a water treatment or water purification process, in particular an advanced oxidation process,
d. a surface functionalisation process, in particular of polymers,
e. a sterilisation, disinfection or decontamination process, in particular of surfaces, medical devices, body surfaces, textiles or wound dressings,
f. a process for producing of nitrates or nitrites, in particular polynitrite,
g. a process for producing hydrogen or synthesis gas; or
h. a therapeutic process.

According to a fifth aspect of the invention, an apparatus is provided for generating a product gas stream, in particular by means of a method according to the first aspect of the invention. The apparatus comprises a discharge chamber for generating a reactive gas stream from a process gas stream, through which discharge chamber the process gas stream can flow. The apparatus further comprises a compressed gas line through which a compressed gas stream of a compressed gas can flow, a reactive gas line which is realized separately from the compressed gas line and through which a reactive gas stream of a reactive gas can flow, and a product gas line through which a product gas stream of a product gas can flow. In addition, the apparatus comprises a mixing chamber which can be brought into flow connection with the compressed gas line and the reactive gas line in such a way that, in the mixing chamber, the compressed gas stream can be mixed with the reactive gas stream to form a product gas stream, and wherein the mixing chamber can be brought into flow connection with the product gas line in such a way that the product gas stream can be discharged from the apparatus by means of the product gas line.

According to a further embodiment, the reactive gas line is located downstream of the discharge chamber.

According to a further embodiment, the reactive gas line is integral with the discharge chamber.

According to a further embodiment, the discharge chamber is realized as a discharge tube.

According to a further embodiment, the apparatus for generating a product gas stream comprises a jet pump, in particular comprising a nozzle, wherein the jet pump is arranged such that a pressure difference between the mixing chamber and the reactive gas line can be generated by means of the compressed gas stream flowing through the jet pump. In this, the nozzle is realized in particular as a Venturi nozzle or a Laval nozzle.

According to a further embodiment, the jet pump is arranged in the mixing chamber or adjacent to the mixing chamber. According to a further embodiment, the jet pump comprises the mixing chamber. According to a further embodiment, the mixing chamber is arranged inside the jet pump. According to a further embodiment, the mixing chamber is integral with the jet pump.

According to a further embodiment, the mixing chamber comprises a diffuser, wherein, in particular, the product gas stream can be transferred to ambient pressure by means of the diffuser.

According to a further embodiment, the process gas can flow through the reactive gas line in a first flow direction and the compressed gas can flow through the compressed gas line in a second flow direction, wherein the first flow direction is arranged not parallel to the second flow direction.

According to a further embodiment, an absolute pressure of 10 mbar to 1000 mbar can be generated in the mixing chamber by means of the jet pump.

According to a further embodiment, the discharge chamber is configured to generate a plasma, in particular by means of a dielectric barrier discharge (DBD), a micro hollow cathode discharge (MHCD) or a corona discharge. In particular, the plasma can be a capacitively coupled plasma (CCP) or an inductively coupled plasma (ICP).

According to a further embodiment, the discharge chamber is configured to generate a non-thermal plasma, in particular at a temperature of 15° C. to 200° C.

According to a further embodiment, the discharge chamber is configured to generate a non-thermal plasma at a temperature of 20° C. to 30° C.

Due to the negative pressure prevailing in the discharge chamber, it is advantageously possible to ignite a plasma at a lower voltage than at atmospheric pressure. This reduces both the manufacturing and operating costs of the apparatus.

Advantageously, by using a jet pump in the described arrangement for mixing the reactive gas stream with the compressed gas stream, it is possible to dispense with flowing the compressed gas stream through the discharge chamber. This enables a more efficient generation of reactive species in the discharge chamber. In particular, the arrangement enables the use of a cost-effective compressed gas, in particular air, water vapour or CO₂, while a process gas optimised for the respective application can be used.

According to a further embodiment, the nozzle of the jet pump has a minimum internal diameter of 0.2 mm to 5 mm.

Due to the small nozzle diameter, it is advantageously possible to use a smaller volume flow of the compressed gas.

According to a further embodiment, the discharge chamber is arranged cylindrically around the mixing chamber.

The advantage of the cylindrical arrangement is that a high mass transfer between the reactive gas stream and the compressed gas stream can be achieved.

According to a further embodiment, the discharge chamber comprises at least one electrode.

According to a further embodiment, the at least one electrode is separated from the discharge chamber, in particular by means of a dielectric.

According to a further embodiment, at least a part of the mixing chamber, in particular at least a part of the jet pump, is realized as an electrode.

According to a further embodiment, at least a part of the compressed gas line is realized as an electrode.

In this, the mixing chamber and/or the compressed gas line can simultaneously serve the mechanical stability of the apparatus.

By using at least a part of the mixing chamber or the compressed gas line as electrode, the latter is cooled by the compressed gas stream, which advantageously reduces heating and thermal expansion of the electrode.

According to a further embodiment, the apparatus comprises a liquid container for receiving a liquid which is arranged adjacent to the discharge chamber, so that the heat generated during operation of the discharge chamber can be used to evaporate a liquid located in the liquid container, in particular wherein the liquid container can be brought into flow connection with the compressed gas line and/or the discharge chamber, so that liquid evaporated in the liquid container can be introduced into the compressed gas line and/or the discharge chamber.

According to a further embodiment, the apparatus for generating a product gas stream comprises a process gas line through which a process gas stream of a process gas can flow, wherein the process gas line can be brought into flow connection with the discharge chamber so that the process gas stream can be introduced into the discharge chamber by means of the process gas line.

According to a further embodiment, the liquid container can be brought into flow connection with the process gas line so that liquid evaporated in the liquid container can be introduced into the process gas line.

According to a further embodiment, the liquid container can be brought into flow connection with the compressed gas line so that liquid evaporated in the liquid container can be introduced into the compressed gas line. In this, the evaporated liquid provides the compressed gas stream or can be added to the compressed gas stream.

According to a further embodiment, the liquid container can be brought into flow connection with the process gas line so that evaporated liquid in the liquid container can be introduced into the process gas line. In this, the evaporated liquid provides the process gas stream or can be added to the process gas stream.

According to a further embodiment, the liquid container can be brought into flow connection with the process gas line and the compressed gas line. In particular, a combined line, which can be brought into flow connection with the liquid container, serves as a combined compressed gas line and process gas line, wherein the line branches at a first branch into a separate compressed gas line and process gas line. In particular, the combined line or the process gas line comprises a throttle valve for throttling the pressure of the process gas stream arranged in the region of the first branch.

According to a further embodiment, the liquid container is directly in flow connection with the jet pump. In this, a part of the liquid container serves as a compressed gas line, wherein the gaseous and/or vapour comprising phase above the liquid serves as the compressed gas, which flow into the jet pump as compressed gas stream via the part of the liquid container realized as the compressed gas line.

According to a further embodiment, the liquid container can be brought into flow connection with the process gas line by means of a throttle valve.

According to a further embodiment, the liquid container is directly in flow connection with the jet pump and the liquid container can be brought into flow connection with the process gas line by means of a throttle valve.

By using the heat generated during operation of the discharge chamber, liquid can advantageously be evaporated without a separate heating device to produce the process gas.

According to a further embodiment, the apparatus comprises a heating device for generating heat, wherein a liquid contained in the liquid container can be evaporated by means of the heating device.

According to a further embodiment, the discharge chamber is located inside the liquid container so that the liquid inside the liquid container can be used to cool the discharge chamber.

According to a further embodiment, the apparatus comprises a cooling device, wherein the reactive gas can be condensed by means of the cooling device.

According to a further embodiment, the apparatus comprises a drying unit arranged downstream of the compressed gas line and upstream of the mixing chamber, wherein the compressed gas can be dried by means of the drying unit.

According to a further embodiment, the apparatus comprises a drying unit arranged downstream of the process gas line and upstream of the discharge chamber, wherein the process gas can be dried by means of the drying unit.

According to a further embodiment, the apparatus comprises a drying unit arranged downstream of the discharge chamber and upstream of the reactive gas line or downstream of the reactive gas line and upstream of the mixing chamber, wherein the reactive gas can be dried by means of the drying unit.

According to a further embodiment, the apparatus comprises a gas washing bottle which can be brought into flow connection with the discharge chamber, so that a process gas can be produced by means of the gas washing bottle by flowing a gas through a liquid located in the gas washing bottle, in particular at reduced pressure compared with atmospheric pressure.

According to a further embodiment, the gas washing bottle can be brought into flow connection with the process gas line.

According to a further embodiment, the gas washing bottle comprises a feed line and a first valve, in particular a controllable valve, wherein the feed gas can be introduced into the liquid contained in the gas washing bottle by means of the feed line and wherein the feed line can be closed by means of the first valve.

According to a further embodiment, the gas washing bottle comprises a short-circuit line which can be brought into flow connection with the feed line and the process gas line and has a second, in particular controllable, valve, wherein a defined proportion of the feed gas or the entire feed gas can be conducted from the feed line into the discharge chamber by means of the short-circuit line without flowing through the liquid contained in the gas washing bottle, and wherein the short-circuit line can be closed by means of the second valve.

The pressure in the gas washing bottle can be regulated by means of the first valve. By regulating the pressure in the gas washing bottle, the composition of the process gas stream and thus of the reactive gas stream can be varied advantageously. For example, it is possible to switch between nitrogen oxide and ozone dominated plasma chemistry.

By adjusting the proportion of feed gas flowing through the gas washing bottle, by means of the second valve, the amount of liquid in the generated process gas can be regulated. In particular, the amount of reactive species formed such as H₂O₂, OH and HO₂ can be influenced when using water as the liquid.

According to a further embodiment, the discharge chamber comprises a third valve, which separates the discharge chamber from the mixing chamber when closed. By simultaneously or successively closing the first valve and the third valve, the current pressure in the discharge chamber and the gas washing bottle can be maintained independently of the compressed gas stream. This enables that after the compressed gas stream or the entire apparatus has been switched off, the negative pressure and any increased humidity in the discharge chamber can be maintained. This enables shorter restart times, as discharge chamber and gas washing bottle do not first have to be pumped out to the required negative pressure.

According to a further embodiment, the apparatus comprises a heating device arranged in the proximity of the gas washing bottle, wherein the liquid contained in the gas washing bottle can be heated by means of the heating device.

According to a further embodiment, the apparatus comprises a liquid container for receiving a liquid and a liquid line, where the liquid line can be brought into flow connection with the compressed gas line and with the liquid contained in the liquid container, so that the liquid can be mixed with the product gas stream or the reactive gas stream and the compressed gas stream.

According to a further embodiment, the liquid can be mixed with the product gas stream.

According to a further embodiment, the liquid can be mixed with the reactive gas stream.

According to a further embodiment, the liquid can be mixed with the compressed gas stream.

According to a further embodiment, the liquid can be mixed with the reactive gas stream and the compressed gas stream.

With a respective apparatus, an aerosol-containing product gas stream can advantageously be produced.

According to a further embodiment, the apparatus comprises a baffle plate arranged inside the mixing chamber for separating larger liquid droplets from an aerosol.

According to a further embodiment, the apparatus comprises a collecting basin for collecting droplets of liquid separated from an aerosol.

According to a further embodiment, the apparatus comprises a baffle plate arranged inside the mixing chamber for separating larger droplets of liquid from an aerosol and a collecting basin for collecting the droplets of liquid separated from an aerosol by the baffle plate.

According to a further embodiment, the apparatus comprises a liquid line for directing a liquid flow from the collecting basin into the mixing chamber, which liquid line is arranged between the collecting basin and the jet pump and can be brought into flow connection with the mixing chamber.

According to a further embodiment, the liquid line comprises a valve for closing or throttling the liquid flow.

According to a further embodiment, the apparatus comprises a container for receiving particles, in particular an abrasive, micro- or nanoparticles, and a particle line, wherein the particle line can be brought into flow connection with the compressed gas line and with particles contained in the container, so that the particles can be mixed with the product gas stream or the reactive gas stream and the compressed gas stream.

According to a further embodiment, the particles can be mixed with the reactive gas stream.

According to a further embodiment, the particles can be mixed with the compressed gas stream.

According to a further embodiment, the particles can be mixed with the reactive gas stream and the compressed gas stream.

With a respective apparatus, a particle-containing product gas stream can be generated, which entails an additional mechanical cleaning effect, in particular in cleaning processes.

Alternatives to individual, separable features described here as embodiments of the invention can be freely combined to obtain further embodiments of the invention.

Further features and advantages of the invention are explained in the following by describing embodiments using figures.

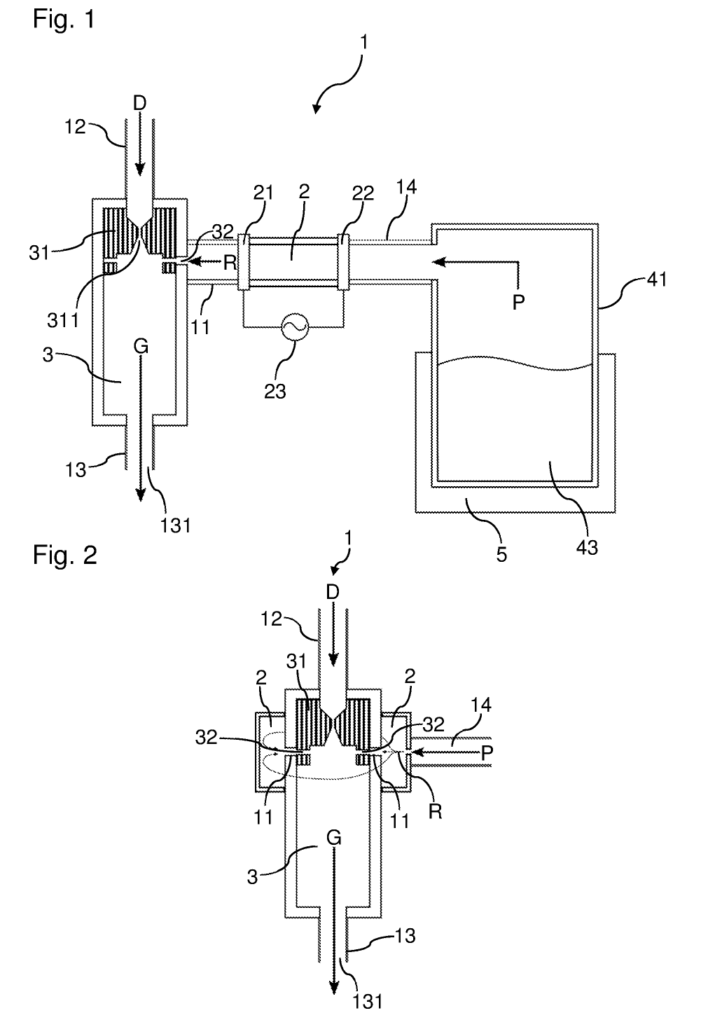

FIG. 1 shows a schematic representation of an apparatus for generating a product gas stream according to the invention,

FIG. 2 shows a schematic representation of a further apparatus according to the invention with a discharge chamber arranged cylindrically around the mixing chamber,

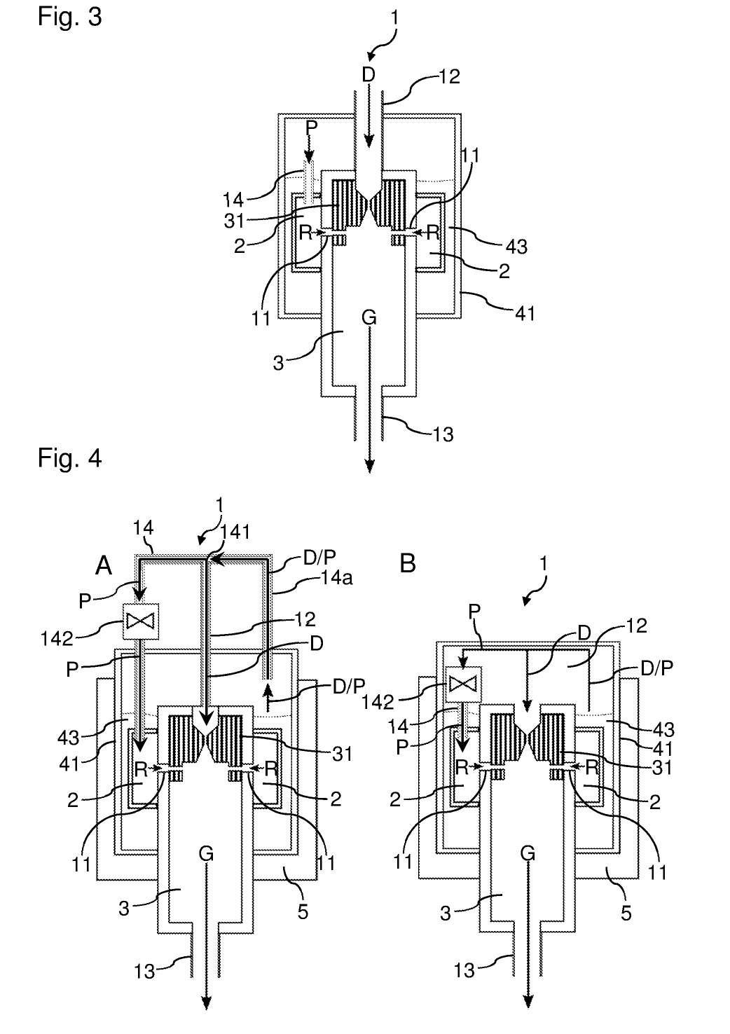

FIG. 3 shows a schematic representation of a further apparatus according to the invention with a liquid container arranged adjacent to the discharge chamber,

FIG. 4 shows a schematic representation of an apparatus realized analogously to the apparatus shown in FIG. 3 with an additional heating device,

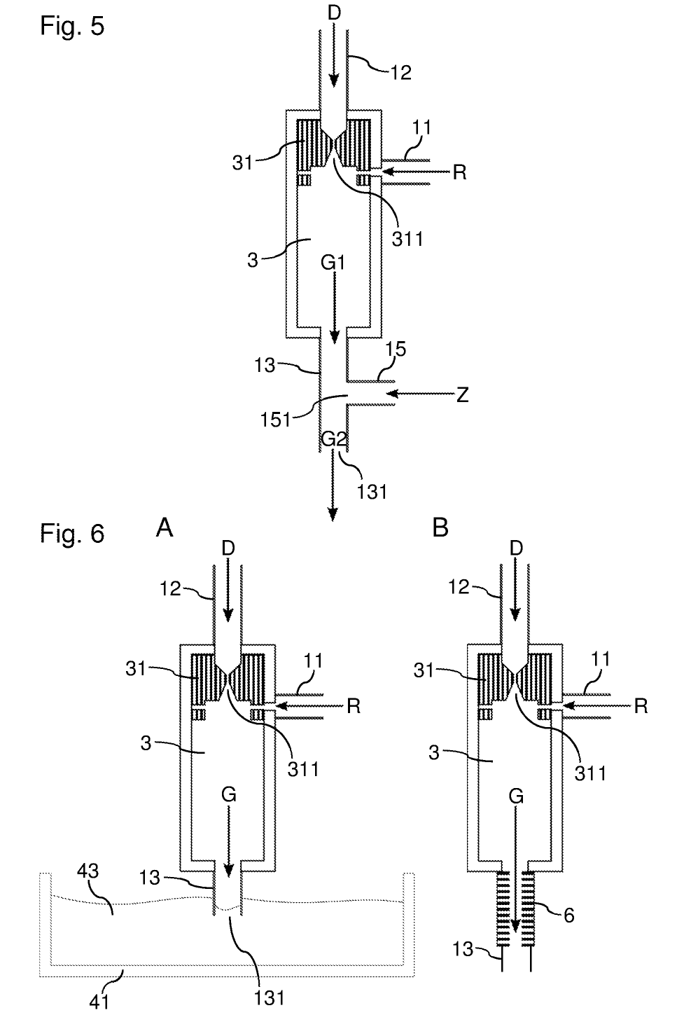

FIG. 5 shows a schematic representation of a mixing device in which the product gas is mixed with an additive gas,

FIG. 6 shows a schematic representation of a mixing chamber with a cooling device and/or a liquid container,

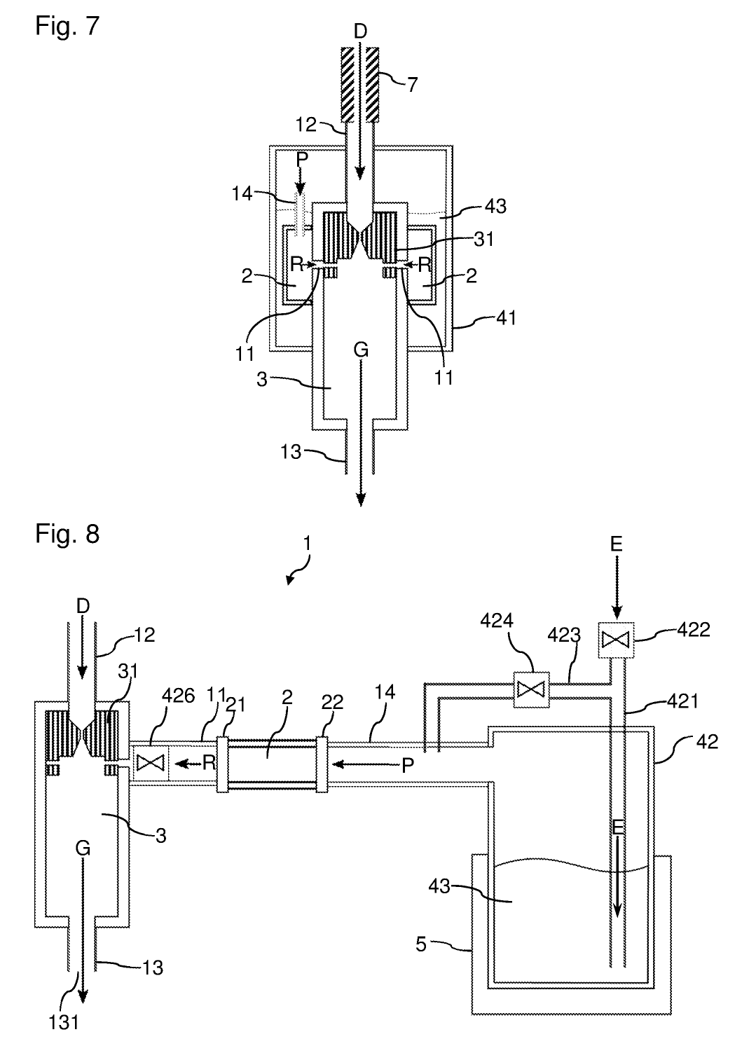

FIG. 7 shows a schematic representation of an apparatus according to the invention with a drying unit,

FIG. 8 shows a schematic representation of an apparatus according to the invention with a gas washing bottle,

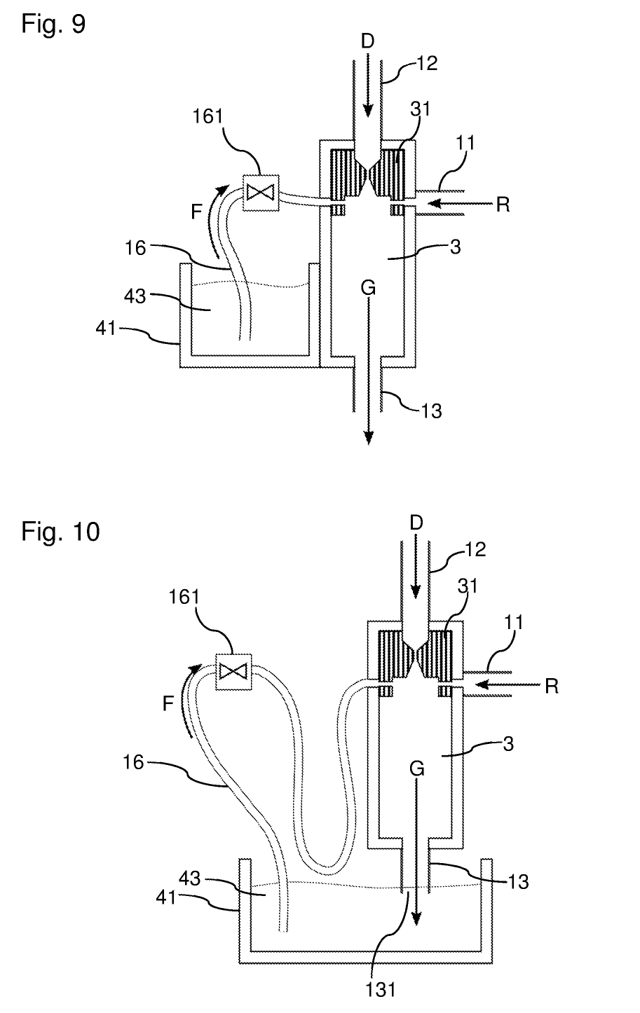

FIG. 9 shows a schematic representation of an apparatus according to the invention with a liquid container and a liquid line,

FIG. 10 shows a schematic representation of an apparatus according to the invention analogous to FIG. 9,

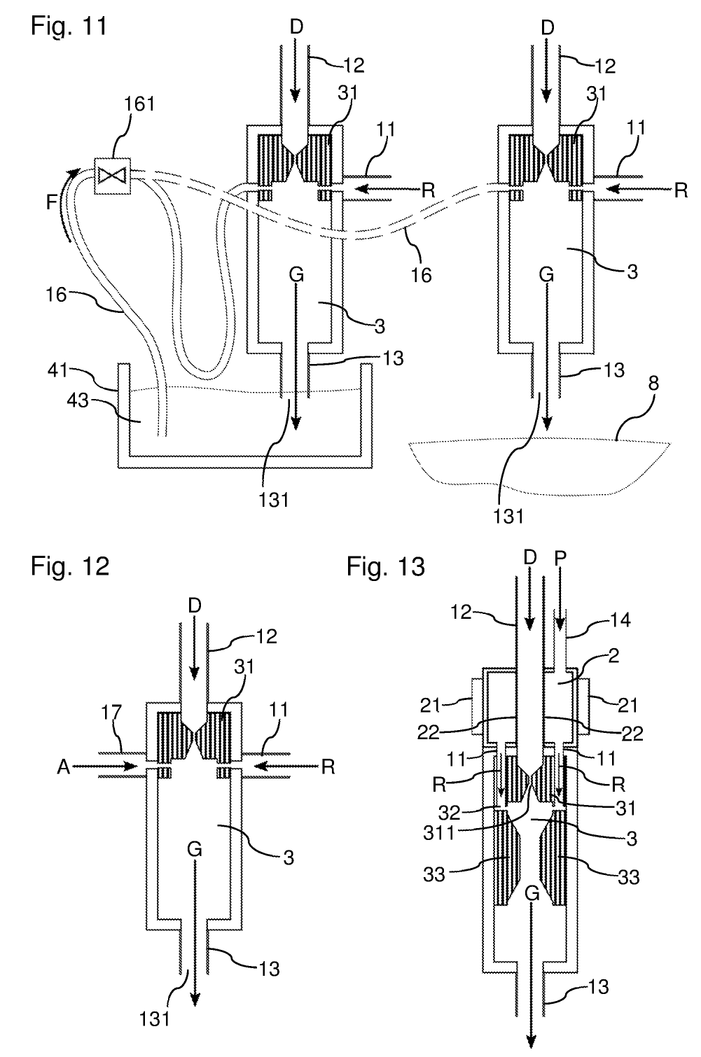

FIG. 11 shows a schematic representation of a use of an apparatus according to the invention,

FIG. 12 shows a schematic representation of part of an apparatus according to the invention,

FIG. 13 shows a schematic representation of part of an apparatus according to the invention,

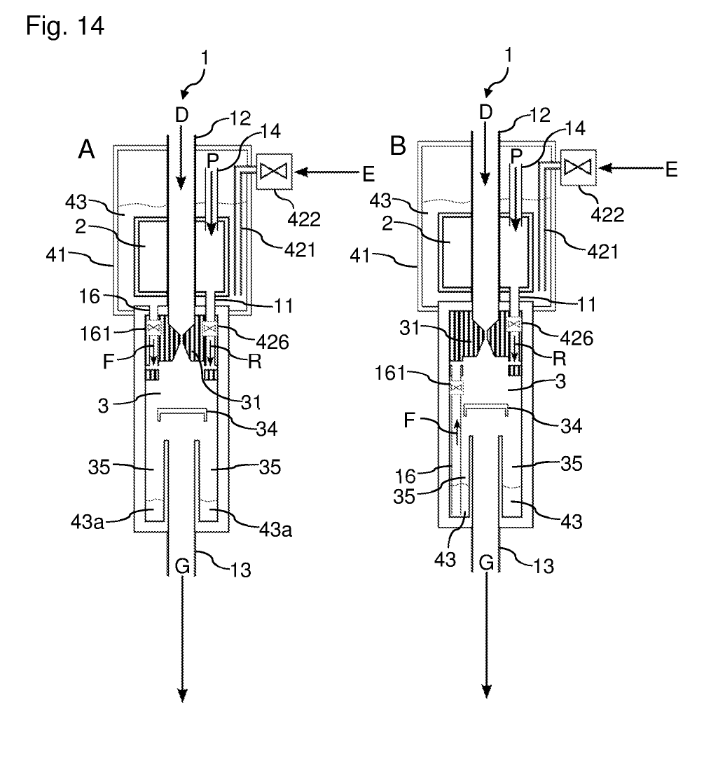

FIG. 14 shows a schematic representation of an apparatus according to the invention with a baffle plate and a collecting basin.

In detail, FIG. 1 shows an apparatus 1 for generating a product gas stream G according to the invention, the apparatus 1 comprising a discharge chamber 2 for generating a plasma, a reactive gas line 11, a compressed gas line 12, a tubular mixing chamber 3 and a product gas line 13. The discharge chamber 2 is in flow connection with the mixing chamber 3 by means of the reactive gas line 11, wherein the reactive gas line 11 opens into the mixing chamber 3 at an opening 32. The mixing chamber 3 is furthermore in flow connection with the compressed gas line 12 and the product gas line 13. As an alternative to the shown arrangement, the flow connections mentioned can be closed, for example by means of valves, and opened as required.

In the shown embodiment, the discharge chamber 2 is shaped as a discharge tube, but other embodiments are also possible. The discharge chamber 2 comprises a first electrode 21 and a second electrode 22, wherein a DC voltage or an AC voltage can be generated between the first electrode 21 and the second electrode 22 by means of a voltage source 23. Alternatively, more than two electrodes can be used. By means of the voltage, a plasma and/or a reactive gas can be formed from the process gas flowing through the discharge chamber 2.

The mixing chamber 3 comprises a jet pump 31, wherein the jet pump 31 is arranged in proximity to the opening 32. The shown jet pump 31 comprises a nozzle 311 which can in particular be realized as a Venturi nozzle or a Laval nozzle.

FIG. 1 further shows a liquid container 41 filled with a liquid 43 and a heating device 5 for heating the liquid 43 contained in the liquid container 41. The shown liquid container 41 is connected to the discharge chamber 2 via a process gas line 14 so that a flow connection is formed between the liquid container 41 and the discharge chamber 2 by means of the process gas line 14. By means of the heating device 5, liquid 43 contained in the liquid container 41 is evaporated, resulting in a process gas. A process gas stream P of the process gas flows through the process gas line 14 into discharge chamber 2, where the process gas is converted into a reactive gas.

By means of the compressed gas line 12, a compressed gas stream D of a compressed gas is introduced into the mixing chamber 3 and flows through the jet pump 31, wherein a pressure difference is generated between the mixing chamber 3 and the reactive gas line 11, In this, a lower pressure prevails in the mixing chamber 3 than in the reactive gas line 11. Due to the generated pressure difference, a reactive gas stream R of the reactive gas is produced from the discharge tube 2 into the mixing chamber 3. As a result of the pressure difference, furthermore a process gas stream P of the process gas comprising evaporated liquid 43 is produced between the gaseous or vaporous upper phase of the liquid container 41 and the discharge chamber 2, flowing through the process gas line 14. Furthermore, the produced pressure difference advantageously causes liquid 43 contained in the liquid container 41 to evaporate at a lowered pressure.

The reactive gas formed in the discharge chamber 2 is sucked into the mixing chamber 3 by the pressure difference. The resulting reactive gas stream R is mixed with the compressed gas stream D in the mixing chamber 3 and forms a product gas stream G. The product gas stream G emerges from the product gas line 13 at an outlet opening 131 and can be applied to solids or liquids, for example.

FIG. 2 shows an apparatus 1 for generating a product gas stream G according to the invention, which is formed analogous to the apparatus 1 according to the invention shown in FIG. 1, with a discharge chamber 2 arranged cylindrically around the mixing chamber 3. The discharge chamber 2 is arranged at least one opening 32 of the mixing chamber 3 and can be brought into flow connection with the mixing chamber 3 by means of the at least one opening 32. In the shown apparatus, the at least one reactive gas line 11 is integrally formed with the discharge chamber 2. The cylindrical arrangement of the discharge chamber 2 around the mixing chamber 3 advantageously maximises the reactive gas stream R between the discharge chamber 2 and the mixing chamber 3 and thus optimises the mixing of the reactive gas stream R with the compressed gas stream D.

FIG. 3 shows an apparatus 1 for generating a product gas stream G according to the invention with a discharge chamber 2 arranged cylindrically around the mixing chamber 3 analogously to the apparatus 1 shown in FIG. 2. In addition, in the apparatus 1 shown in FIG. 3 the liquid container 41 is arranged cylindrically around the mixing chamber 3 and adjacent to the discharge chamber 2, so that heat which is in particular generated by the operation of the discharge chamber 2 can be transferred from the discharge chamber 2 to the liquid container 41 and the liquid 43 contained therein. By means of the transferred heat, for example, a part of the liquid 43 contained in the liquid container 41 can be evaporated, wherein in particular the discharge chamber 2 is cooled.

FIG. 4A shows an apparatus 1 for generating a product gas stream G according to the invention with a discharge chamber 2 arranged cylindrically around the mixing chamber 3 analogously to the apparatus 1 shown in FIG. 3 and a liquid container 41 arranged cylindrically adjacent to the discharge chamber 2, wherein the apparatus 1 additionally comprises a heating device 5 for heating the liquid 43 located in the liquid container 41 which is arranged adjacent to the liquid container 41.

Furthermore, FIG. 4A shows a combined pressure and process gas line 14a which can be brought into flow connection with a liquid container 41 containing liquid 43 in such a way that evaporated liquid 43 can flow through the combined pressure and process gas line 14a. In this case, the same gas stream serves both as compressed gas stream D and as process gas stream P. At a first branch 141, the combined compressed and process gas line 14a is divided into a compressed gas line 12 and a process gas line 14, wherein the compressed gas line 12 can be brought into flow connection with the mixing chamber 3, and wherein the process gas line 14 can be brought into flow connection with the discharge chamber 2. A throttle valve 142 is arranged in the process gas line 14 downstream of the first branch 141. The pressure of the process gas stream P can be throttled by means of the throttle valve 142.

FIG. 4B shows an arrangement equivalent in function to FIG. 4A, which differs in that the combined pressure and process gas line 14 a can be omitted, since a throttle valve 142 is arranged inside the liquid container 41. Here, the part of the liquid container 41 not filled with the liquid 43 is in flow connection with the mixing chamber 3 directly via the jet pump 31, so that the gas phase above the liquid 43, which in particular is under pressure, can flow through the jet pump 31 into the mixing chamber 3 as a compressed gas stream D. The gas phase, which is under pressure above the liquid 43 in particular, can flow through the jet pump 31. In addition, the gas phase located above the liquid 43 is connected to the discharge chamber 2 via the throttle valve 142, so that the gas phase can flow into the discharge chamber 2 as process gas stream P with its pressure being throttled. The upper part of the liquid container 41 serves as the compressed gas line 12.

FIG. 5 shows a mixing chamber 3 with a jet pump 31, which comprises a nozzle 311, in particular as part of an apparatus 1 for generating a product gas stream G according to invention. The mixing chamber 3 is flown through by a compressed gas stream D, which enters the mixing chamber 3 from a compressed gas line 12 which is in flow connection with the mixing chamber 3. FIG. 5 also shows a reactive gas line 11 which can be brought into flow connection with the mixing chamber 3 and through which a reactive gas stream R flows into the mixing chamber 3. In the mixing chamber 3, the reactive gas stream R is mixed with the compressed gas stream D, wherein a first product gas stream G1 is formed, which leaves the mixing chamber 3 through a product gas line 13 which can be brought into flow connection with the mixing chamber 3.

The product gas line 13 is connected at a second branch 151 with an additional gas line 15. An additional gas stream Z of an additional gas flows through the additional gas line 15, which mixes at the second branch 151 with the first product gas stream G1 with formation of a second product gas stream G2. The second product gas stream G2 leaves the apparatus 1 at the outlet opening 131.

FIG. 6A shows a mixing chamber 3 with a jet pump 31, which comprises a nozzle 311, in particular as part of an apparatus 1 for generating a product gas stream G according to invention. The mixing chamber 3 is flown through by a compressed gas stream D, which enters the mixing chamber 3 from a compressed gas line 12 which is in flow connection with the mixing chamber 3. FIG. 5 also shows a reactive gas line 11 which can be brought into flow connection with the mixing chamber 3 and through which a reactive gas stream R flows into the mixing chamber 3. In the mixing chamber 3, the reactive gas stream R is mixed with the compressed gas stream D, wherein a product gas stream G1 is formed, which leaves the mixing chamber 3 through a product gas line 13 which can be brought into flow connection with the mixing chamber 3.

In the arrangement shown in FIG. 6A, the product gas stream G leaving the mixing chamber 3 through the product gas line 13 and the outlet opening 131 is led into a liquid container 41 filled with a liquid 43. In particular, a component of the product gas can be condensed by cooling.

FIG. 6B shows a mixing chamber 3 with a jet pump 31 analogous to the mixing chamber 3 shown in FIG. 6A, in particular as part of an apparatus 1 for generating a product gas stream G according to the invention, wherein the mixing chamber 3 comprises a cooling device 6 arranged downstream with respect to the product gas stream G, in particular a cooling line, which can be brought into flow connection with the mixing chamber 3. By means of the cooling device 6, in particular a component of the product gas can be condensed by cooling.

FIG. 7 shows an apparatus 1 for generating a product gas stream G according to the invention, wherein the apparatus 1 is formed analogously to the apparatus 1 shown in FIG. 3. The apparatus 1 comprises a drying unit 7 which, with respect to the compressed gas stream D, is arranged upstream of the mixing chamber 3 and downstream of the compressed gas line 12 in flow connection with the mixing chamber 3 and the compressed gas line 12. By means of the drying unit 7, in particular the compressed gas stream D can be dried before being introduced into the mixing chamber 3.

FIG. 8 shows an apparatus 1 for generating a product gas stream G according to the invention which is formed analogously to the apparatus shown in FIG. 1 and additionally comprises a gas washing bottle 42 filled with a liquid 43 and a heating device 5 for heating the liquid 43 contained in the gas washing bottle 42. The gas washing bottle 42 comprises a feed line 421 for introducing a feed gas stream E of a feed gas into the liquid 43. The feed line 421 comprises a first valve 422 for throttling or closing the feed line 421.

Furthermore, the gas washing bottle 42 shown in FIG. 8 can be brought into flow connection with a process gas line 14. The gas wash bottle 42 also comprises a short-circuit line 423 that can be brought into flow connection with the feed line 421 and the process gas line 14, wherein the short-circuit line 423 comprises a second valve 424 for throttling and/or closing the short-circuit line 423.

FIG. 8 also shows a third valve 426 for throttling the reactive gas stream R or closing the reactive gas line 11. By simultaneously or successively closing valves 424 and 426, the negative pressure and any increased humidity in the discharge chamber 2 can be maintained without the presence of a compressed gas stream D.

The mixing chamber 3 is flown through by a compressed gas stream D, which enters the mixing chamber 3 from the compressed gas line 12. In this, a pressure difference is generated between the mixing chamber 3 and the reactive gas line 11 analogous to the apparatus 1 shown in FIG. 1, wherein a lower pressure prevails in the mixing chamber 3 than in the reactive gas line 11.

Due to the flow connection between the process gas line 14 and the gas washing bottle 42, a higher pressure also prevails in the gas washing bottle 42 than in the mixing chamber 3 when the compressed gas stream D flows through the pressurised gas line 12.

A feed gas stream E of a feed gas is introduced into the gas washing bottle 42 by means of the feed line 421, wherein the feed gas stream E is controllable by means of the first valve 422 by closing the feed line 421. The feed line 421 is arranged in such a way that if the gas washing bottle 42 is sufficiently filled with a liquid 43, the feed line 421 opens into the liquid 43, so that the feed gas stream E can be introduced into the liquid 43. In this way, the feed gas stream E can be enriched with evaporated liquid 43, forming a process gas stream P. The enrichment of the feed gas stream E with evaporated liquid 43 can be controlled by means of the short-circuit line 423 and the second valve 424. In this, the enrichment of the feed gas stream E with evaporated liquid 43 is reduced if the short-circuit line 423 is opened by means of the second valve 424.

The formed process gas stream P is then led into the discharge chamber 2 by means of the process gas line 14, analogous to the apparatus 1 shown in FIG. 1, where a reactive gas is formed from the process gas, wherein a reactive gas stream R is formed. The reactive gas stream R is sucked into the mixing chamber 3 by means of the reactive gas line 11 and mixed there with the compressed gas stream D, wherein a product gas stream G is formed.

FIG. 9 shows an apparatus with a mixing chamber 3, in particular as part of an apparatus 1 for generating a product gas stream G which is configured analogously to one of the apparatuses 1 shown in the preceding figures, and a liquid container 41 for receiving a liquid 43. FIG. 9 also shows a liquid line 16, wherein one end of the liquid line 16 is arranged in the liquid container 41 in such a way that liquid 43 can be sucked into the liquid line 16. The liquid line 16 comprises a liquid valve 161, wherein the liquid line 16 can be closed by means of the liquid valve 161. The liquid line 16 can be brought into flow connection with the mixing chamber 3 via a jet pump 31, so that a liquid flow F of the liquid 43 can be introduced into the mixing chamber 3 via the liquid line 16. A compressed gas stream D flows from the compressed gas line 12 into the mixing chamber 3. In addition, a reactive gas stream R of a reactive gas, formed in particular in a discharge chamber 2, is sucked into the mixing chamber 3 via a reactive gas line 11 which opens into the mixing chamber 3.

In the mixing chamber 3 an aerosol is formed by mixing the compressed gas stream D, the reactive gas stream R and the liquid 43, wherein the aerosol, as part of a product gas stream G, is led out of the mixing chamber 3 via the product gas line 13.

FIG. 10 shows an apparatus analogous to the apparatus shown in FIG. 9, in particular as part of an apparatus 1 for generating a product gas stream G analogous to one of the apparatuses 1 shown in the preceding figures. The product gas line 13 of the apparatus 1 is arranged above the liquid container 41 in such a way that the product gas stream G emerging from the outlet opening 131 of the product gas line 13 can be introduced into the liquid 43. In this, reactive gas is added to the liquid 43. Subsequently, a liquid flow F of the liquid 43 is introduced again into the mixing chamber 3 via the liquid line 16 and the jet pump 31 and mixed with the compressed gas stream D and the reactive gas stream R. This increases the concentration of reactive atoms and/or molecules in the formed aerosol.

FIG. 11 shows the use of an apparatus analogous to the apparatus shown in FIG. 10. First, a product gas stream G with an aerosol containing reactive atoms and/or molecules is generated by introducing a liquid 43 via the jet pump 31 into the mixing chamber 3 (FIG. 11A). Subsequently, the product gas stream G is applied to a target object 8 (FIG. 11B).

FIG. 12 shows a part of an apparatus 1 configured analogously to one of the apparatuses 1 shown in the FIGS. 1 to 10, wherein the apparatus 1 additionally comprises a particle line 17 opening into the mixing chamber 3 for transporting particles, in particular an abrasive or microparticles or nanoparticles. By means of the particle line 17, a particle stream A of particles can be introduced into the mixing chamber 3, wherein the particle stream A is mixed with the compressed gas stream D and the reactive gas stream R, wherein a product gas stream G comprising particles is formed.

FIG. 13 shows a detailed view of a part of an apparatus 1 according to the invention with a mixing chamber 3, a compressed gas line 12 that can be brought into flow connection with the mixing chamber 3 and a discharge chamber 2 arranged cylindrically around the compressed gas line 12.

The mixing chamber 3 comprises a jet pump 31 with a nozzle 311 and a diffuser 33 which is arranged downstream of the nozzle 311 and which can be brought into flow connection with the product gas line 13.

FIG. 13 further shows two reactive gas lines 11, each representing a flow connection between the discharge chamber 2 and the mixing chamber 3. The outer wall of the discharge chamber 2 forms a first electrode 21 and the inner wall of the discharge chamber 2 forms a second electrode 22. A voltage can be generated between the first electrode 21 and the second electrode 22, by means of which a discharge is caused in the discharge chamber 2.

From the compressed gas line 12 a compressed gas stream D flows into the mixing chamber 3 and from the process gas line 14 a process gas stream P flows into the discharge chamber 2, where a reactive gas is formed from the process gas. In the example shown, the compressed gas stream D and the process gas stream P run in parallel directions.

By means of the compressed gas stream D flowing through the nozzle 311, a negative pressure is generated in the mixing chamber 3 with respect to the discharge chamber 2 and/or the reactive gas lines 11, so that the reactive gas stream R from the discharge chamber 2 enters the mixing chamber 3 through at least one opening 32.

As a result, the compressed gas stream D and the reactive gas stream R are mixed in the mixing chamber 3 to form a product gas stream G. The pressure of the product gas stream G is increased as it flows through the diffuser 33, wherein simultaneously the flow velocity is reduced. From the diffuser 33 the product gas stream G flows through the product gas line 13 and leaves it through the outlet opening 131.

FIG. 14 A shows an apparatus for generating a product gas stream G with a compressed gas line 12 which is connected via a jet pump 31 to a mixing chamber 3, wherein the mixing chamber 3 is furthermore in flow connection with a product gas line 13. A discharge chamber 2 for generating a reactive gas is arranged cylindrically around a part of the compressed gas line 12, the discharge chamber 2 in turn being inside a liquid container 41 arranged cylindrically around the discharge chamber 2. In the arrangement shown, the liquid container 41 is filled with a liquid 43 so that the entire discharge chamber 2 is below the liquid level. However, a smaller amount of liquid 43 may be contained in the liquid container 41 so that only a part of the discharge chamber 2 is below the liquid level. In particular, the discharge chamber 2 can be cooled by the liquid 43 during operation.

The discharge chamber 2 is connected to the gaseous or phase present as vapour above the liquid 43 via a process gas line 14, so that the upper phase can enter the discharge chamber 2 in the form of a process gas stream P, so that a reactive gas can be formed from the process gas by means of the discharge tube 2.

The composition of the phase present above the liquid 43 in the liquid container 41 can be controlled analogously to the arrangement shown in FIG. 8 via the introduction of a feed gas stream E via the feed line 421 into the liquid 43, wherein the feed line 421 can be throttled or closed by means of a first valve 422.

The discharge chamber 2 is connected to the mixing chamber 3 via a reactive gas line 11 which can be closed by a third valve 426, so that a reactive gas stream R of the reactive gas can be introduced into the mixing chamber 3. In analogy to the apparatuses described above, the pressure difference generated by the compressed gas stream D flowing through the jet pump 31 is used to introduce the reactive gas stream R into the mixing chamber 3 and to mix the flows D and R.

FIG. 14 also shows a liquid line 16 connecting the liquid container 41 with the mixing chamber 3. The liquid line 16 can be throttled or closed via a liquid valve 161. By means of the liquid line 16, liquid 43 contained in the liquid container 41 can be introduced as liquid flow F into the mixing chamber 3, where in particular the liquid flow F can be mixed with the compressed gas stream D and the reactive gas stream R in analogy to the configurations shown in FIGS. 9 and 10 with formation of a product gas stream G comprising an aerosol.

The shown apparatus 1 also comprises a baffle plate 34 which is configured to separate larger liquid droplets formed of the aerosol from the aerosol. The separated liquid 43a separated from the aerosol collects in a collecting basin 35 which is arranged cylindrically around the product gas line 13.

FIG. 14 B shows an apparatus for generating a product gas stream G formed analogously to the apparatus shown in FIG. 14 A, wherein the liquid line 16 is arranged in such a way that liquid 43 present in the collecting basin 35 is sucked in by means of the jet pump 31, flows as liquid flow F through the liquid line 16, exits into the mixing chamber 3 and mixes there with the compressed gas stream D and the reactive gas stream R with formation of an aerosol, wherein, as in the case of the apparatus shown in FIG. 14 A, larger liquid droplets can be separated from the aerosol by means of the baffle plate 34. These droplets collect in the collecting basin 35.

### Example 1—Generation of a Reactive Aerosol

With the following example it is shown that by igniting a plasma in an air-water vapour process gas at a pressure of 400 mbar using a jet pump (Venturi pump), a reactive aerosol can be generated which exhibits antimicrobial activity for a few minutes after its generation.

With a jet pump, a negative pressure was generated in a discharge chamber and in a gas washing bottle connected to the discharge chamber in terms of flow. In the discharge chamber a plasma was ignited by applying an alternating voltage (frequency: 30 kHz, voltage amplitude: 6 kV) to an inner electrode according to the principle of dielectrically impeded discharge. An air-water vapour process gas was generated by means of a thermally insulated gas washing bottle that could be heated with a heating plate.

After mixing the reactive gas generated by the plasma with compressed air, which was used to operate the jet pump, a product gas stream/aerosol was formed. The aerosol was collected in a beaker for further investigation. The concentration of hydrogen peroxide (H₂O₂) and nitrite (NO₂⁻) and the pH value of the generated aerosol were determined by means of corresponding test strips (Merck KGaA, Germany),

A measurement of the concentration of H₂O₂ and NO₂ and the pH value directly after collecting 1 ml of the aerosol and 3 minutes after collecting the aerosol resulted in the values listed in Table 1.

TABLE 1
measured values

| | H₂O₂/mgL⁻¹ | NO₂_{^{−}}/mgL⁻¹ | pH |
|---|---|---|---|
| directly after generation | 200 | 40 | 2.5 |
| new measurement after 3 | 150 | below limit of detection | 2.5 |
| minutes | | | |

It can be seen from the values that after generating the aerosol, further chemical reactions take place in the liquid in which NO₂⁻ and H₂O₂ are converted. The technical literature shows that H₂O₂ and NO₂⁻ have an antimicrobial effect at low pH values (preferably about 2 to 4), which results at least partly from the formation of peroxynitrite (ONOOH) in the liquid. The reaction

NO₂⁻+H₂O₂+H⁺→ONOOH+H₂O (1)

takes place, wherein the reaction product peroxynitrite is known to have an antimicrobial effect. In this experiment, water was used as the liquid to be evaporated. According to reaction equation (1), nitrous acid (by providing NO₂⁻), H₂O₂ or nitric acid (by lowering the pH value) can also be used to increase the reaction rate.

In all cases, a reactive product gas stream is generated in which peroxynitrite is formed for a short time, which then reacts to further products within a short time. The half-life of ONOOH is typically less than 1 s. With the method according to the invention and/or the apparatus according to the invention, particularly high concentrations of H₂O₂ and NO₂⁻ can be achieved (up to 700 mg/L).

The known reaction coefficients for reaction (1), for example about 20 M⁻¹s⁻¹ at a pH value of 2.5, show that the half-life of the educts NO₂⁻ and/or H₂O₂ in this case is of the order of one second. The apparatus according to the invention is capable of applying the reactive product gas stream to a treating surface before a large part of the reactive species NO₂⁻ and H₂O₂ has already reacted with each other according to reaction (1) and is therefore no longer available for the local formation of peroxynitrite.

### LIST OF REFERENCE SIGNS

| | |
|---|---|
| 1 | Apparatus for Generating a Product Gas Stream |
| 11 | Reactive Gas Line |
| 12 | Compressed Gas Line |
| 13 | Product Gas Line |
| 131 | Outlet Opening |
| 14 | Process Gas Line |
| 14a | Combined Pressure and Process Gas Line |
| 141 | First Branch |
| 142 | Throttle Valve |
| 15 | Additional Gas Line |
| 151 | Second Branch |
| 16 | Liquid Line |
| 161 | Liquid Valve |
| 17 | Particle Line |
| 2 | Discharge Chamber |
| 21 | First Electrode |
| 22 | Second Electrode |
| 23 | Voltage Source |
| 3 | Mixing Chamber |
| 31 | Jet Pump |
| 311 | Nozzle |
| 32 | Opening |
| 33 | Diffuser |
| 34 | Baffle Plate |
| 35 | Collecting Basin |
| 41 | Liquid Container |
| 42 | Gas Washing Bottle |
| 421 | Feed Line |
| 422 | First Valve |
| 423 | Short-Circuit Line |
| 424 | Second Valve |
| 426 | Third Valve |
| 43 | Liquid |
| 43a | Separated Liquid |
| 5 | Heating Device |
| 6 | Cooling Device |
| 7 | Drying Unit |
| 8 | Target Object |
| P | Process Gas Stream |
| R | Reactive Gas Stream |
| D | Compressed Gas Stream |
| G | Product Gas Stream |
| G1 | First Product Gas Stream |
| Z | Additional Gas Stream |
| G2 | Second Product Gas Stream |
| F | Liquid Flow |
| E | Feed Gas Stream |
| A | Particle Stream |

1. Method for generating a product gas stream (G), the method comprising the following steps:
a. Provision of a process gas stream (P) of a process gas, wherein at least one component of the process gas is provided by evaporating a liquid selected from water, hydrogen peroxide (H₂O₂), nitrous acid (HNO₂), nitric acid (HNO₃) or an alcohol,
b. Provision of a reactive gas stream (R) by generating a reactive gas from the process gas by means of a discharge chamber (2) at reduced pressure compared with atmospheric pressure, in particular 10 mbar to 1000 mbar,
c. Provision of a compressed gas stream (D) of a compressed gas,
d. Mixing the reactive gas stream (R) with the compressed gas stream (D) with formation of a product gas stream (G).

2. Method according to claim 1, wherein the liquid is evaporated by means of the heat released during operation of the discharge chamber (2).

3. Method according to claim 1, wherein at least a part of the process gas stream (P) is branched off from the process gas stream (P) to provide the compressed gas stream (D).

4. Method according to claim 1, wherein a first product gas stream (G1) is formed by mixing the compressed gas stream (D) and the reactive gas stream (R) and the first product gas stream (G1) is mixed with an additive gas stream (Z) of an additive gas with formation of a second product gas stream (G2).

5. Method according to claim 4, wherein a chemical reaction takes place between a component of the first product gas stream (G1), in particular OH, and a component of the additive gas stream (Z), in particular NO₂, in particular with formation of HOONO.

6. Method according to claim 1, wherein the reactive gas stream (R) is mixed with a liquid with formation of an aerosol.

7. Method according to claim 6, wherein the formed product gas stream (G) is introduced into the liquid and the liquid mixed with the product gas stream (G) is mixed again with the reactive gas stream (R).

8. Method according to claim 1, wherein the product gas stream (G) or the reactive gas stream (R) and the compressed gas stream (D) is mixed with a particle stream (A), in particular comprising an abrasive, micro- or nanoparticles.

9. Method according to claim 1, wherein by increasing or decreasing the pressure prevailing in the discharge chamber (2), a switch is made between an O₃-dominated state and a NOₓ-dominated state of the discharge chamber (2), and wherein
at a gas temperature between 20° C. and 150° C. the O₃ dominated state is present at a pressure of 600 mbar to 1000 mbar and the NOₓ dominated state is present at a pressure of 20 mbar to 400 mbar, or
at a gas temperature between 150° C. and 200° C. the O₃ dominated state is present at a pressure of 800 mbar to 1000 mbar and the NOₓ dominated state is present at a pressure of 20 mbar to 600 mbar.

10. Product gas stream (G), in particular generated by a method according to claim 1, comprising at least 10 mg/L hydrogen peroxide (H₂O₂) and at least 10 mg/L nitrite (NO₂⁻), in particular at least 50 mg/L hydrogen peroxide (H₂O₂) and at least 50 mg/L nitrite (NO₂⁻), preferably at least 100 mg/L hydrogen peroxide (H₂O₂) and at least 100 mg/L nitrite (NO₂⁻).

11. Product gas stream (G) according to claim 10, having a pH value of 6.0 or less.

12. (canceled)

13. Apparatus (1) for generating a product gas stream (G), in particular by means of a method according to claim 1, comprising
a discharge chamber (2) for generating a reactive gas stream (R) from a process gas stream (P), through which discharge chamber (2) the process gas stream (P) can flow,
a compressed gas line (12) through which a compressed gas stream (D) of a compressed gas can flow,
a reactive gas line (11) which is realized separately from the compressed gas line (12) and through which a reactive gas stream (R) of a reactive gas can flow,
a product gas line (13) through which a product gas stream (G) of a product gas can flow,
characterised in that
the apparatus (1) comprises a mixing chamber (3) which can be brought into flow connection with the compressed gas line (12) and the reactive gas line (11) in such a way that, in the mixing chamber (3), the compressed gas stream (D) can be mixed with the reactive gas stream (R) to form a product gas stream (G), wherein the mixing chamber (3) can be brought into flow connection with the product gas line (13) in such a way that the product gas stream (13) can be discharged from the apparatus (1) by means of the product gas line (13), wherein the discharge chamber (2) is arranged cylindrically around the mixing chamber (3).

14. Apparatus according to claim 13, wherein the apparatus (1) comprises a jet pump (31), in particular comprising a nozzle (311), and wherein the jet pump (31) is arranged such that a pressure difference between the mixing chamber (3) and the reactive gas line (11) can be generated by means of the compressed gas stream (D) flowing through the jet pump (31).

15. Apparatus according to claim 13, wherein the apparatus (1) comprises a liquid container for receiving a liquid (41) which is arranged adjacent to the discharge chamber (2), so that the heat generated during operation of the discharge chamber (2) can be used to evaporate a liquid (43) located in the liquid container (41), in particular wherein the liquid container (41) can be brought into flow connection with the compressed gas line (12) and/or the discharge chamber (2), so that liquid evaporated in the liquid container (41) can be introduced into the compressed gas line (12) and/or the discharge chamber (2).

16. Apparatus according to claim 13, wherein the apparatus (1) comprises a gas washing bottle (42) which can be brought into flow connection with the discharge chamber (2), so that a process gas can be produced by means of the gas washing bottle (42) by flowing a feed gas through a liquid (43) located in the gas washing bottle (42), in particular at reduced pressure compared with atmospheric pressure.
